(19) United States
(12) Patent Application Publication
(10) Pub. No.: US 2016/0343010 A1
(43) Pub. Date: Nov. 24, 2016

(54) OPPORTUNITY DASHBOARD

(71) Applicant: Xtime Inc., Redwood Shores, CA (US)

(72) Inventors: H. Neal East, III, Half Moon Bay, CA (US); Matthew Wyman, Half Moon Bay, CA (US); Adam David Springer, San Ramon, CA (US); Adam R. Galper, Palo Alto, CA (US)

(21) Appl. No.: 14/319,424

(22) Filed: Jun. 30, 2014

(51) Int. Cl. G06Q 30/02; G06Q 10/00

(52) U.S. Cl. CPC G06Q 30/0202; G06Q 10/20

(57) ABSTRACT

Approaches for providing embodiments of an opportunity dashboard are presented, comprising receiving vehicle service data, wherein the vehicle service data comprises service work performed on vehicles over a predetermined period of past time; calculating an estimated future demand for vehicle service work over a predetermined period of future time based on the vehicle service data; calculating an estimated maximum future capacity for vehicle service work over the predetermined period of future time based on the vehicle service data; analyzing constraints on the capacity for vehicle service work over the predetermined period of future time; modifying the estimated maximum future capacity for vehicle service work over a predetermined period of future time based on the constraints; determining a difference between the estimated maximum future capacity for vehicle service work over a predetermined period of future time and the estimated future demand; and converting the difference into monetary value.

### BACKGROUND

Due to the low margins and financing obligations from car manufacturers, car dealers rely heavily upon revenue from servicing cars in order to turn a profit. The service department at a car dealer is generally managed via one or more modules of a Dealer Management System (DMS), which is software used by most dealers to operate the various aspects of their business. The DMS may include modules for inventory, financing, marketing, and other aspects of the dealer's business.

Whether the service department is managed via a DMS or not, the same concerns arise with regard to administering a profitable service department. Service departments have many people with various skills organized into different teams, a finite number of resources (people, tools, parts, service bays, time), and uncertain demands on the resources.

Current approaches utilize naïve scheduling techniques that result in wide swings in resource utilization on any given day, thereby failing to maximize crucial potential revenue from the service department.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram illustrating example components of a system 100 implementing embodiments of an opportunity dashboard and related techniques, as described herein;

FIG. 2 is a block diagram 200 illustrating an example of a user interface for viewing an opportunity dashboard, according to some embodiments;

FIG. 3 is a block diagram 300 illustrating an example of a user interface for viewing an opportunity dashboard, according to some embodiments;

FIG. 4 is a block diagram 400 illustrating an example of a user interface for viewing an opportunity dashboard, according to some embodiments;

FIG. 5 is a block diagram 500 illustrating an example of a user interface for performing scheduling and marketing activities, according to some embodiments;

FIG. 6 is a flow diagram 600 illustrating example steps for providing an opportunity dashboard according to an embodiment of the invention;

FIG. 7 is a block diagram 700 illustrating components of a machine, according to some example embodiments, able to read instructions from a machine-readable medium and perform any one or more of the methodologies discussed herein.

### DETAILED DESCRIPTION OF THE INVENTION

Approaches for detecting, predicting, and visualizing costs, opportunity and revenue in a service department, along with generating and displaying an opportunity dashboard, are presented herein. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details. In other instances, well-known structures and devices are shown in block diagram form or discussed at a high level in order to avoid unnecessarily obscuring teachings of embodiments of the invention.

In an embodiment, an approach is described for methods, systems, devices, and non-transitory machine-readable storage medium that cause receiving vehicle service data, wherein the vehicle service data comprises service work performed on vehicles over a predetermined period of past time; calculating an estimated future demand for vehicle service work over a predetermined period of future time based on the vehicle service data; calculating an estimated maximum future capacity for vehicle service work over the predetermined period of future time based on the vehicle service data; analyzing constraints on the capacity for vehicle service work over the predetermined period of future time; modifying the estimated maximum future capacity for vehicle service work over a predetermined period of future time based on the constraints; determining a difference between the estimated maximum future capacity for vehicle service work over a predetermined period of future time and the estimated future demand; and converting the difference into monetary value.

### Overview

Embodiments of the opportunity dashboard process data and utilize predictive approaches to detect, predict, and visualize dealer costs, opportunities and revenues from service, for example by calculating future unused capacity at a dealer and targeting marketing opportunities to specific audiences to fill the unused capacity.

Embodiments use past data over varying time periods to predict future events over varying time periods. In an example, the past five weeks for a service department may be highly predictive of the next three. By calculating both potential future demand as well as constraints on future supply, a concept of “opportunity” may be derived and visualized so that a dealership may make informed decisions regarding future decisions such as marketing, staffing, resource allocation, etc.

While the notion of “capacity” may be calculated in one example as simply the number of hours available for technicians to work in a single period, the notion of “opportunity” is a broader concept that draws not only upon predicting future demand based on past behavior, but also setting goals that take into account sophisticated supply-based analysis.

In an example, past trend information regarding service hours performed may be visualized, and the underlying data analyzed to predict future trends. This data may be confined to total service hours from X weeks ago being used to predict Y service hours being performed in Y weeks, wherein the predictions are calculated based upon past data as well as data already existing about future appointments, and predictions about walk-ins along with scheduled service appointments.

The gap between service hours possible and predicted may be presented visually to illustrate how much revenue is being lost due to inefficient allocation of resources and a failure to fill all available hours. In an embodiment, marketing campaigns are initiated to fill unused capacity based upon specific target audiences and dates.

### Opportunity Dashboard

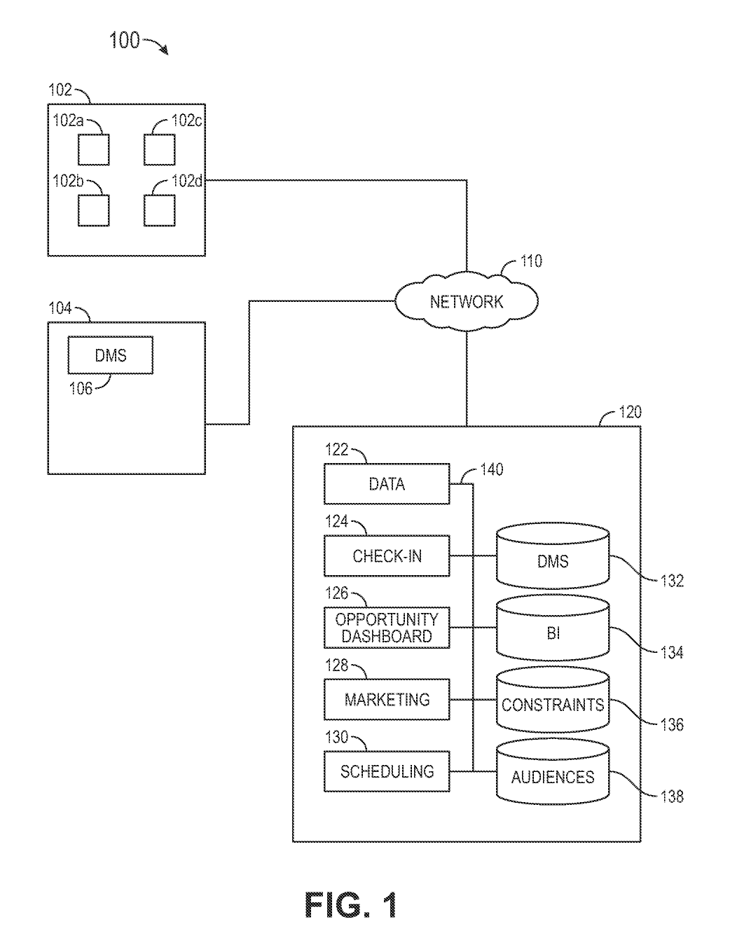

FIG. 1 is a block diagram illustrating example components of a system 100 implementing embodiments of an opportunity dashboard and related techniques, as described herein. System 100 includes customers 102, dealers 104, and an example opportunity dashboard system 120, all communicatively connected via one or more networks 110.

In an embodiment, multiple systems 100 are envisioned. The multiple systems 100 may, individually or as a group, contain a different combination of modules and elements described below, such as combining multiple modules into a single module, eliminating certain modules, or adding additional components and/or modules that may provide additional functionality as known in the art. The multiple systems 100 may be communicatively connected, either fully or in any combination of individual systems or modules. These modules may be implemented in hardware or software and may comprise internal connections (not shown in FIG. 1) allowing the various modules to be communicatively coupled in any desired configuration, as well as allowing one or more modules to be communicatively coupled to external devices. Additional modules not explicitly shown in FIG. 1 may also be included in system 100 in other embodiments, and modules and/or their functionality may be combined or divided into further modules in various embodiments.

Customers 102 may be comprised of any number of individuals or entities 102a-102d, typically accessing a client-facing website or similar interface for users (e.g., in-car telematics, etc.) embodying techniques described herein via a network 110. Customers 102 may access the opportunity dashboard system 120 via a personal computer, a mobile computing device, or any other type of electronic device configured to display a user interface and communicate with resources over a network.

Dealers 104 generally comprise automobile dealers with a service department, although the approaches described herein are not so limited. Dealers 104 may also include independent car service shops, new and/or used car dealers, car rental agencies, or any other type of entity connected with automobiles. Often, dealer 104 is utilizing a DMS 106, which may be executing on a computer local to the dealer 104, but may also be executing external to the physical dealer location, such as via cloud computing techniques or on a third party server communicatively connected to the dealer 104 via a network 110.

DMS 106 may be a monolithic program, or may be comprised of sub-modules such as inventory, sales, inventory, finance, insurance, service, etc. In some embodiments, DMS 106 may be extended with add-on modules or 3^{rd} party software that may communicate with the main DMS 106. Some DMS 106 also perform HR and accounting functions.

Network 110 may comprise the Internet, an intranet, a local area network (LAN), a virtual private network (VPN), and/or any type of wired or wireless data communication technique known in the art. Multiple networks may be utilized to effectuate different aspects of the techniques described herein.

The opportunity dashboard system 120 may be comprised of multiple modules, each executing on one or more computing devices in one or more different locations, each module capable of communicating and sharing data with any other module via internal or external data connections, such as internal bus/socket connections, network connections, or data storage devices such as flash storage.

The opportunity dashboard system 120 may be executing on a computer such as a server, but may also be executing via cloud computing techniques or on multiple servers communicatively connected to the dealer 104 and the customers 102 via a network 110.

The data synchronization and normalization module 122 in one example operates to control data transfer, synchronization, and normalization between opportunity dashboard system 120 and dealers 104, specifically the DMS 106 or similar software executing on behalf of the dealer 104. When data is transferred between DMS 106 and opportunity dashboard system 120, data synchronization and normalization module 122 controls the flow of data to ensure accurate transfer, as well as normalizing the data from DMS 106 into a common model compatible with opportunity dashboard system 120.

In an example, there may be hundreds of dealers 104 sending data to opportunity dashboard system 120, and each dealer 104 may have a different code identifying an oil change in their DMS 106. This data needs to be normalized for use by opportunity dashboard system 120 so that accurate identification, computation, and visualization of dealer capacities and opportunities may be undertaken, as described more fully herein. Additionally, DMS 106 data may describe other attributes used by opportunity dashboard system 120, such as the identity of service advisors and their skills, what types of vehicles the dealer has, the services they perform, the teams into which the service advisors are organized, how long various services should take, etc. Data synchronization and normalization module 122 in an embodiment receives the necessary data from multiple dealers 104, performs data normalization techniques known in the art to create data compatible with opportunity dashboard system 120, and may operate to communicate the data to the appropriate module within opportunity dashboard system 120. Additionally, data synchronization and normalization module 122 may operate to control the flow of data from opportunity dashboard system 120 to dealers 104 and their DMS 106, performing a translation of data if necessary so that data compatible with each DMS 106 is transmitted. In an embodiment, all data transmitted in and out of opportunity dashboard system 120 flows through data synchronization and normalization module 122.

Check-in module 124 determines when a particular customer has “checked in” to a dealer service department; for example, when a person has a 9 AM appointment for an oil change, and they arrive for the appointment, a service advisor enters data into the DMS 106 indicating that the car has arrived. This data is transmitted to opportunity dashboard system 120 and check-in module 124 uses the data to filter the calculations performed by opportunity dashboard system 120 (either itself or by transmitting the data to another module) because a variable (whether or not the appointment will show up) has been resolved. Additionally, dealers often have people “walk-in” for a service appointment; for example, a person may bring her car in for an oil change during her lunch break without having made an appointment. Check-in module 124 receives this data from a DMS 106 and communicates the data to the appropriate module of opportunity dashboard system 120 for further calculations. In an embodiment, check-in module 124 makes a determination whether a customer is a scheduled appointment or a walk-in based on data from a DMS 106 indicating that a car has arrived for service.

Opportunity dashboard module 126 in one embodiment operates to perform the identification, calculation, and visualization of “opportunity” for a dealer 104, as discussed more fully herein.

Marketing module 128 in one example performs the necessary computations to determine a specific marketing opportunity for a dealer 104, and to receive marketing choices from a dealer 104 that may be presented to a consumer, for example in concert with scheduling module 130. Scheduling module 130 may receive consumer choices regarding service scheduling and transmit the choices to DMS 106 for scheduling at the dealership.

For example, marketing module 128 may determine that, based on data from the audience database 138, it would be advantageous to offer a special on oil changes on a particular day and time. This special may be marketed to specific customers who log into their account on a dealer website, for example. Once a customer chooses to bring their car in for the oil change at a particular day and time, the scheduling module transmits this data to DMS 106 so that the dealer 104 can have an up-to-date schedule of pending service appointments. Data in this example flows from marketing module 128 to scheduling module 130, to a customer (e.g., via a website), then back from the customer 102a to scheduling module 130 and back to the DMS 106 at a dealer 104. Examples of this are discussed more fully herein.

DMS database 132 in an example comprises data from a dealer DMS 106; for example, the service advisors, their schedules, their billing rates, the services they perform, etc. In an example, this serves as a local cache (e.g., a replica) of the DMS 106 data locally to opportunity dashboard system 120.

Business intelligence module 134 in one example stores past aggregate behavior and contains business rules to be applied in various situations. For example, data used to determine what specific time slot to market, which cars to market to based on a particular audience set, which marketing campaign to use for a particular audience set, etc.

Constraints module 136 stores constraints on resources; for example, the number of greeters at a dealer, the number of loaner cars at a dealer, the number of lifts at a dealer, etc. This concept is described more fully herein.

Audience module 138 stores data pertaining to audience sets. In an example, “audiences” are specific target groups of potential customers who may be identified and described via information such as: who the owner is (demographic data such as location, job, gender, age, etc.), what make/model/year the car is (from which service predictions may be made based on similar cars and what service issues arose and at what mileage), and the maintenance schedule for a car (manufacturer and/or dealer). In an example, an audience may be a group representing a segment of the population, which may be classified based upon criteria such as demographics (e.g., income levels, geography, etc.). In an example, higher income owners may perform basic services such as oil changes more often. Similarly, the same Year/Make/Model truck may be used in a very different manner from one segment to another based on economic and demographic classifications. In another example, buying patterns and social network connections may be predictive of service behaviors. Another example would be the likelihood of an audience member to purchase a specific brand of tire or to have an oil change done based on cost and or social network experience with the dealer (e.g., reviews). An audience may also comprise a set of people who have had a service offered or presented to them in the past, for example through marketing efforts or at a vehicle check-in. These previously-presented services could have been offered as a result of an inspection. An example is a service advisor during check-in noticing that one or more tires are worn and offering to sell and install replacement tires, perhaps with a discount. An audience could also be defined in relation to other types of past visit behavior, for example appointments and appointment patterns, such as when a person usually brings in their car(s) for service. Other aspects of past visit behavior could be whether a person typically takes advantage of promotions and/or discounts (e.g., coupons), whether they have been “upsold” (i.e., has a service advisor gotten them to add a service to their visit that was not originally scheduled), and generally the outcome of their previous visits and purchases at the dealer (including buying cars from the dealer).

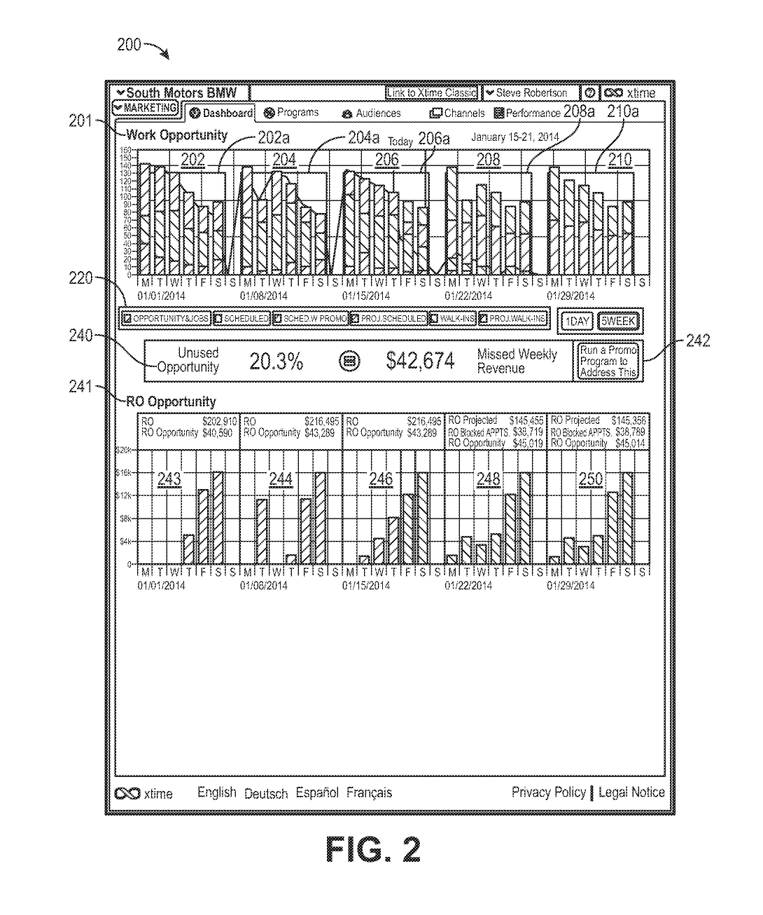

FIG. 2 is a block diagram 200 illustrating an example of a user interface for viewing an opportunity dashboard, according to some embodiments. In the example interface (e.g., presented as a web page), work opportunity 201 for five weeks 202-210 is presented, with today's date 206 being in the center and the portion of the interface to the left of today's date 206 being past performance and the portion of the interface to the right of today's date 206 being projected future performance. Although any number of variable time periods may be used. In this example, each week is broken down further into days, with a bar graph indicating number of hours worked (although any data point may be graphed, such as dollars, service technicians, etc.). For example, on Monday, 01/01/2014, the bar graph indicates that about 140 hours were worked, a high for the week 202.

Each bar graph may be segmented into categories. In the example of FIG. 2, the legend 220 indicates that one color represents scheduled work, which may comprise all work done for which the customer scheduled an appointment. Another color represents work scheduled with a promotion, which may comprise all work done for which the customer scheduled an appointment and used a promotion (e.g., a coupon). Another color may represent work done for walk-ins, which may comprise all work done for which the customer did not schedule an appointment.

Additional colors represent future-looking projections based on data such as past behavior. One, discussed more fully below, is opportunity and jobs. Another color may represent all projected scheduled work, while another color may represent all projected walk-in work. Other data points may be added or substituted for the ones illustrated in FIG. 2, and any manner of graphical presentation known in the art may be used to present the data.

The opportunity and jobs metric is represented in FIG. 2 by a gray box 202a-210a, although any type of indication may be used. In an embodiment, this box 202a-210a indicates what the dealer could do (capacity) based on an average of its peak performance. By evaluating past performance (e.g., X number of hours across a particular time period), a projection may be calculated regarding how many hours could be worked per day in the future. For example, for the past time period covering the week of 01/01/2014 202, the opportunity and jobs metric 202a indicates that Monday and Tuesday came in above projected peak performance while Thursday, Friday, and Saturday were well below potential.

In an embodiment, this opportunity and jobs metric represents peak capacity that is calculated based on past behavior. It's what the dealer could do based on an analysis of its peak performance, and is a demand-based projection. By analyzing past performance, and metrics, projections for each day in the future may be formulated and displayed. In one example, it could encompass an average of (scheduled appointments+Scheduled with promotion+Walk-ins) over the past X number of days. For example, future weeks 208-210 may be projected, broken down into categories such as projected scheduled and projected walk-ins, along with the opportunity and jobs metric 208a-210a being displayed, which shows the dealer whether the future projections are taking up all of the projected capacity. If not, then the dealer not maximizing revenue, and will know that steps should be taken to bring more people in on days where the projected demand is low. For example, on Tuesday the week of 01/22/2014 208, demand is projected to be below peak capacity, so a marketing program could be manually or automatically generated to bring in more business that day.

In another example embodiment, a supply-based “goal metric” may be computed and displayed, such as with a line graph overlay or other graphical element. In this example, additional data regarding the particular constraints on any given day is analyzed along with the demand-based forecasting model to arrive at a goal metric. In an embodiment, the goal metric is based on specific information regarding the resources of a particular dealership at a point in time. Examples of constraints used in the analysis may comprise the available employees, their skills and specialties, the teams into which they are organized, the number of greeters, the number of service bays in operation, available equipment and parts, conflicts between various services, loaner cars, waiting room size, etc. Any data point that could limit the supply of hours that a dealership could potentially devote to servicing cars on any given day could be used in the analysis. These data points could be raw supply (such as number of loaner cars, waiting room size, etc.) or be updated in real-time (e.g., how many loaner cars are currently in use, how many people are currently in the waiting room, etc.).

In an example, the opportunity and jobs metric 202a-210a may take into account demand for service hours during a previous time period in order to arrive at a projection of service hours that could be expected to be performed in the future, while the goal metric analyzes the constraints on resources at any given time to determine what may actually be done based on the supply of resources. If two service advisors will be on vacation in two weeks, then the goal metric will show this reduction in potential utilization. As the goal metric would be below the opportunity and jobs metric, a dealership may want to take various actions in response, such as hiring temporary workers or reducing the number of appointments they are taking for that time period.

FIG. 2 also illustrates an example metric for Repair Order (“RO”) Opportunity 241 on the same time scale 243-250 as Work Opportunity 201. In this example, the information contained within the Work Opportunity 201 metrics are translated into actual revenue that is being lost due to failing to work at peak capacity. As with Work Opportunity 201, RO Opportunity 241 shows precise amounts for past time periods 243-246 and projected amounts for future time periods 246-250, with breakdowns in the data available, such as scheduled appointments versus walk-ins, etc.

In an embodiment, specific services (e.g., types of ROs) may be taken into account when calculating Work Opportunity 201 and goal metrics. For example, by analyzing historical data with regard to what services have been performed and classifying the data into appropriate categories, a profile of work at a given dealership may be calculated, which is an example could become a constraint used in future calculations. For example, if a dealership does a particular amount of oil changes per month, but has the capacity to do more high-margin work such as transmission overhauls if the number of oil changes were reduced (a service bay used for an oil change cannot be used for other work), then this could be expressed as lost opportunity. Additional data points such as employee skills, available tools and parts, and even waiting room size may be involved in making these calculations. An oil change may only require one service technician of moderate skill and space in a waiting area is only needed for 30 minutes, while a transmission overhaul may require two technicians of advanced skill and waiting room space for 4 hours. From analyzing such constraint-based data, a calculation of lost opportunity may be created that shows a dealer where resources may better be utilized. Booking too many oil changes left the dealer with less capacity for more profitable work.

This capacity modeling may be used to calculate a total percentage of unused opportunity 240, which may be translated into lost revenue. In an example, unused opportunity may be calculated as (For each day in the current week (Opportunity & Jobs−SUM (Scheduled, Walk-ins, Scheduled with Promotion, Projected Scheduled, Projected Walk-ins))/(Opportunity & Jobs*number of days in the current week), where in one example Opportunity=(Average of scheduled+Scheduled with Promotion+Walk-ins) count by day of the top 3 days over a “historic number of days” period, and where in one example Jobs=(Scheduled+Scheduled with Promotion+Walk-ins) for each of the days in the “historic number of days” period. “Projected Scheduled” and “Projected Walk-ins” may in various examples be averages taken over a period of time. An interface element may provide a quick way for a dealer to take action 242, such as running a promotion to increase demand.

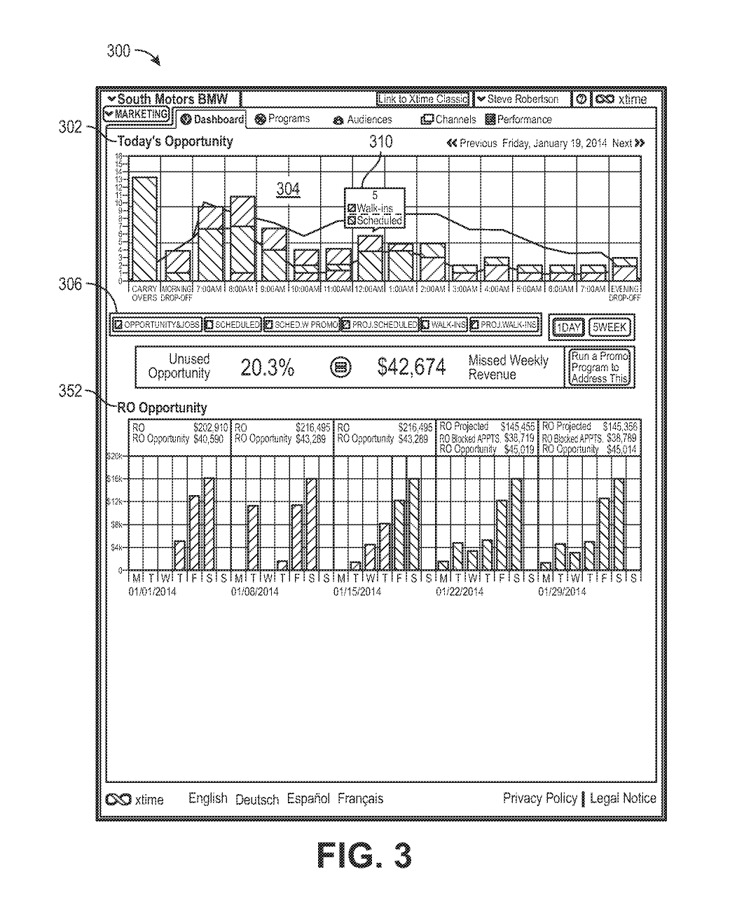

In an example, clicking on a particular day in the Work Opportunity 201 display brings up a drill-down of that day, illustrated in FIG. 3, which is a block diagram 300 illustrating an example of a user interface for viewing an opportunity dashboard, according to some embodiments. In FIG. 3, the day is illustrated as “Today's Opportunity” 302 and may be broken down 304 into hourly segments or any other time period for a particular day.

In this example, each hour shows an opportunity and jobs metric based on past performance along with a breakdown 306 of each sub-time period. For hours in the past, actual data may be displayed, while future hours yet to come are based on projections. In an example, by hovering an input device over a particular time period, even more granular breakdowns may be displayed.

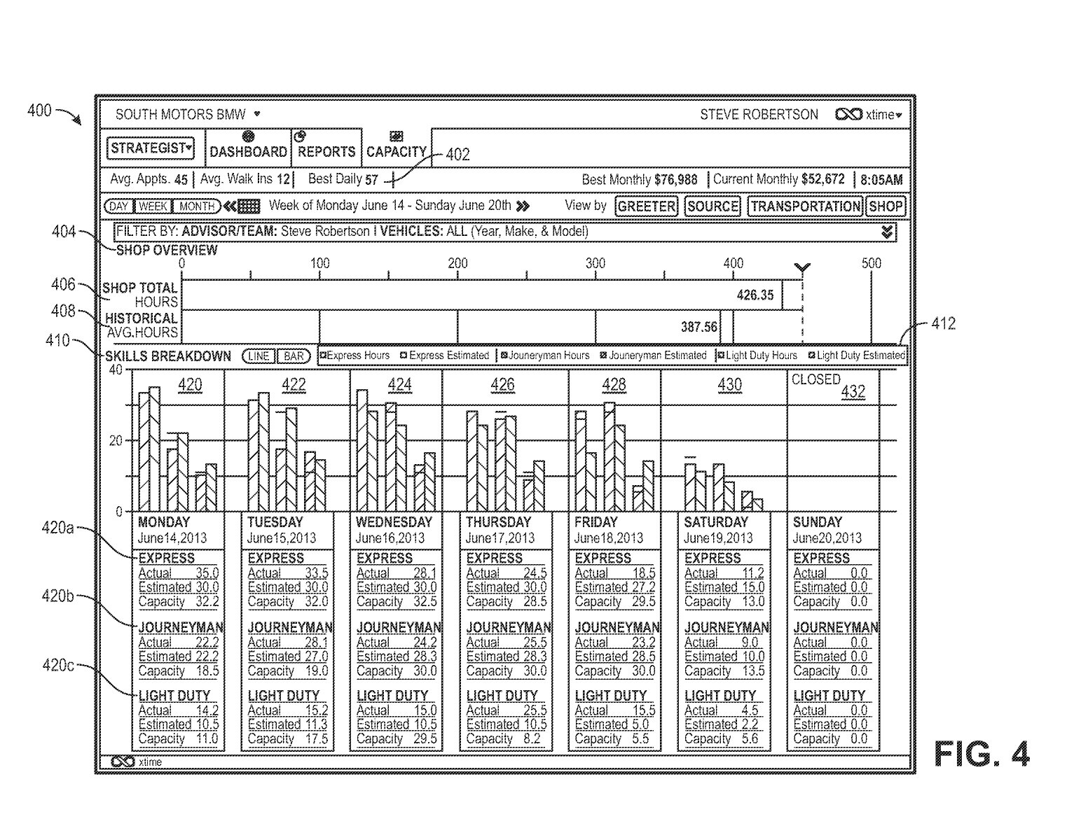

FIG. 4 is a block diagram 400 illustrating an example of a user interface for viewing an opportunity dashboard, according to some embodiments. In FIG. 4, an interface for determining how skills are being consumed. For example, given the skills defined by the data received and normalized from a DMS 106, a series of time periods may be analyzed to calculate how the available skills of service technicians are being consumed and project a potential capacity of hours given the designated skills.

In an example, skill definitions for service technicians are created at a dealer 104 and input into the DMS 106. This data is consumed and normalized by the opportunity dashboard system 120. Dealers may identify each individual working in service (e.g., mechanics) and what skills they have, along with what teams they may be assigned to. Dealers may create teams of mechanics for different reasons. For example, a dealer may want to have one person with each potential skill on a team, while in other examples all team members have the same skill. Skills may be associated with services, and then skills to a person and a person to a team. Example skill definitions may encompass labels such as “master technician,” “journeyman,” and other titles, some of which may be “certified,” for example, with a manufacturer or labor organization. Other skills may be related to areas of a car for which the technician is especially proficient. Each skills may be associated with varying labor rates.

If a dealer indicates that they have to have a team of three people with skills X, Y, and Z in order to do a particular service, then in order to predict capacity to perform the service, data related to the team members' availability and capacity may be used to calculate the future prediction. By analyzing this data, suggestions may be created to maximize team performance; for example, one dealer may be using a four-person team for transmission repairs while other similarly-situated dealerships may only be using three-member teams of certain skills to do transmission repairs.

In FIG. 4, data may be displayed indicating what was done, what was estimated, and what the potential capacity was over a given time period given the defined technicians and their skills, along with how their skills are being consumed. A summary tab 402 may be displayed illustrating various data regarding, for example, average number of appointments and average number of walk-ins over a given time period, best daily performance over a given time period, and revenue dollar amounts for particular time periods.

A shop overview section 404 may illustrate the total number of service hours 406 for the chosen time period, along with a historical measure of utilized shop hours 408 for a given time period for comparison purposes. While “shop hours” is discussed with regard to FIG. 4, any measure of work or performance is contemplated.

In an embodiment, a skills breakdown 410 section may be displayed wherein the chosen time period is broken down into sub-periods 420-432, such as days in a week. As discussed above, various predetermined classifications of technicians and/or their skills may be calculated and displayed 420a-420c. A calculation of actual hours worked, estimated hours worked, and capacity (possible hours that could have been worked, for example taking constraints into account) may also be provided, whether it is a historical calculation or a projected amount.

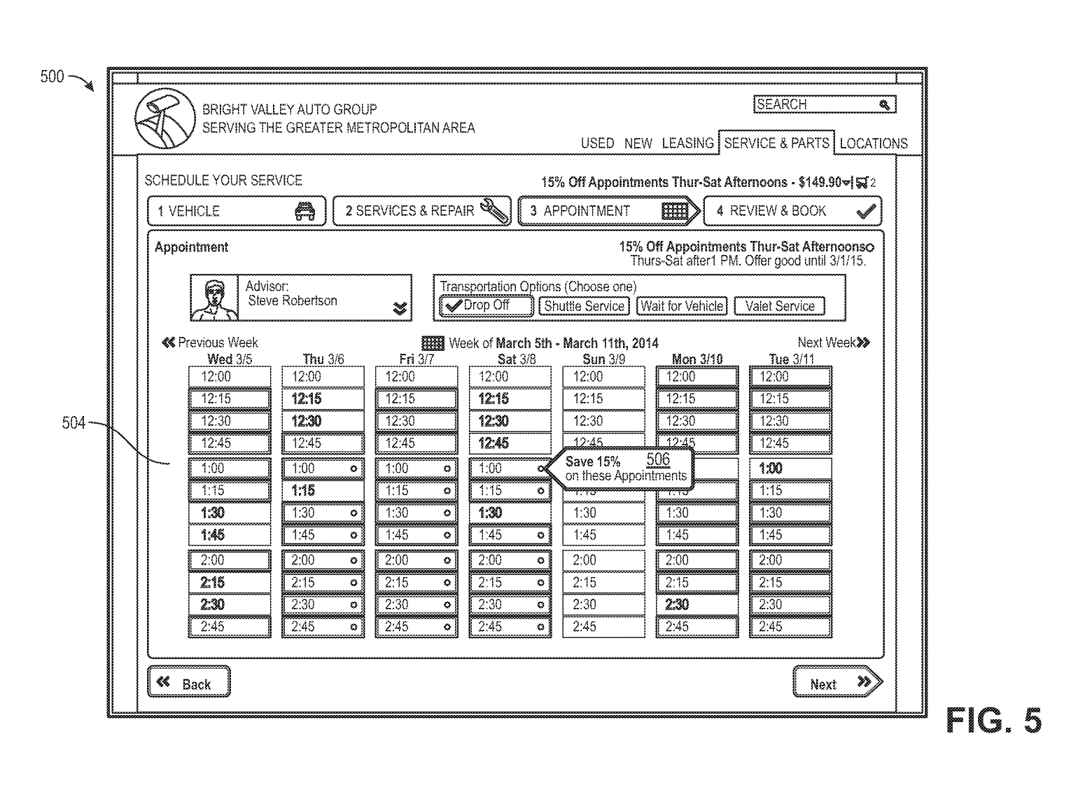

FIG. 5 is a block diagram 500 illustrating an example of a user interface for performing scheduling and marketing activities, according to some embodiments. Based on the analysis performed by opportunity dashboard system 120 with regard to opportunity and jobs metrics and goal metrics, it may be determined that marketing programs should be initiated in order to fill unused capacity and increase revenue, and such programs may be automatically generated based on the opportunity projections, as described earlier. A schedule of potential appointment times 504 may be presented in an embodiment, with a particular time 506 identified via opportunity calculations highlighted with a promotion. Any type of promotion is envisioned: percent off, free loaner/rental, complementary services, etc. As particular opportunities are identified, for example based on day/time (in one example taking constraints into account), audience, type of service, etc., then marketing approaches may be automatically generated and presented to a user such as a client, a service advisor, etc.

In an example, the audience database 138 and marketing module 128 may determine that particular opportunities require specific marketing approaches. For example, some marketing approaches target trust (e.g., assurance of needs being met, such as having loaners available) while others target price based on who the target audience is. Some marketing approaches are directed towards filling specific time slots or specific underutilized teams and team members. For example, if the opportunity dashboard system 120 determines that next Friday projects to have three hours of unused capacity, then based on the constraints on supply, the marketing module 128 may suggest a campaign to get three separate jobs into the shop (e.g., three oil changes) or a job that projects to take three hours (e.g., a brake replacement). Based on the type of job(s) determined to best fill the unused capacity, then the appropriate audience may be selected. In an embodiment, the marketing may encompass demand-based pricing schemes. If the marketing to directed towards oil changes, then it would be less efficient to target people who have just brought in their car for a scheduled service interval where oil changes were performed. Instead, the target audience may include people who have not been in for service in some time, or offer a coupon for an oil change to people who have brought their car in for service with coupons in the past.

In the example of FIG. 5, an interface is provided to a potential customer (i.e., via a scheduling web portal initiated by clicking on a link in a marketing email) that displays a selected time period's worth of open time slots 504 for the chosen services. If the opportunity dashboard system 120 determines that a specific time slot should be filled as part of an approach to maximize opportunity for a specific day, then a marketing promotion may be displayed for that specific time slot 506.

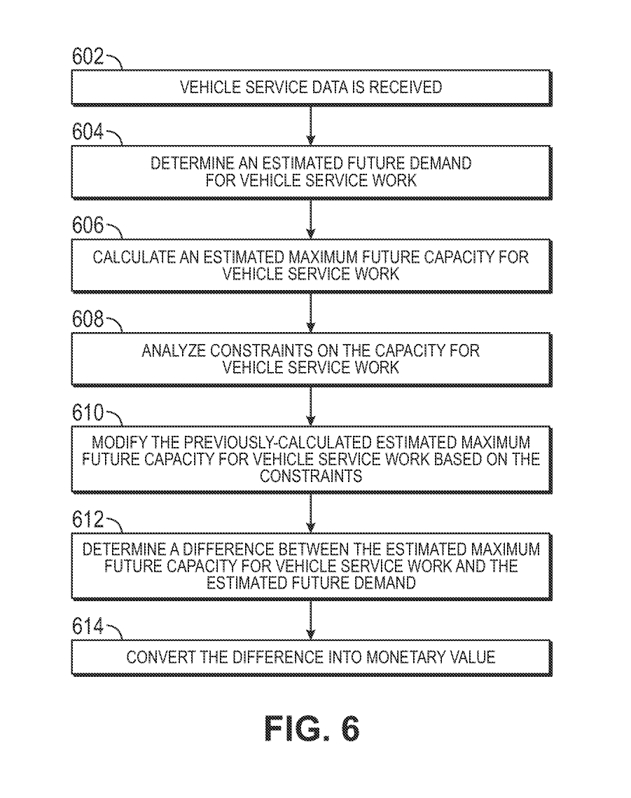

FIG. 6 is a flowchart 600 illustrating an example embodiment of an opportunity dashboard. At 602, vehicle service data is received, in an example where the vehicle service data comprises service work performed on vehicles over a predetermined period of past time and may be sourced from a DMS or other data source, including real-time data entry.

At 604, an estimated future demand for vehicle service work over a predetermined period of future time is calculated, where the estimated future demand may be based on the vehicle service data.

At 606, an estimated maximum future capacity for vehicle service work over the predetermined period of future time is calculated, in an example based on the vehicle service data.

At 608, constraints on the capacity for vehicle service work over the predetermined period of future time are analyzed; for example, predetermined constraints such as waiting room size, loaner cars, number of technicians, perhaps with specific skills, etc. In various embodiments, the constraints are calculated in real-time based on up-to-date data related to the constraints.

At 610, the previously-calculated estimated maximum future capacity for vehicle service work over a predetermined period of future time is modified based on the constraints.

At 612, a difference between the estimated maximum future capacity for vehicle service work over a predetermined period of future time and the estimated future demand is determined.

At 614, this difference is converted into monetary value.

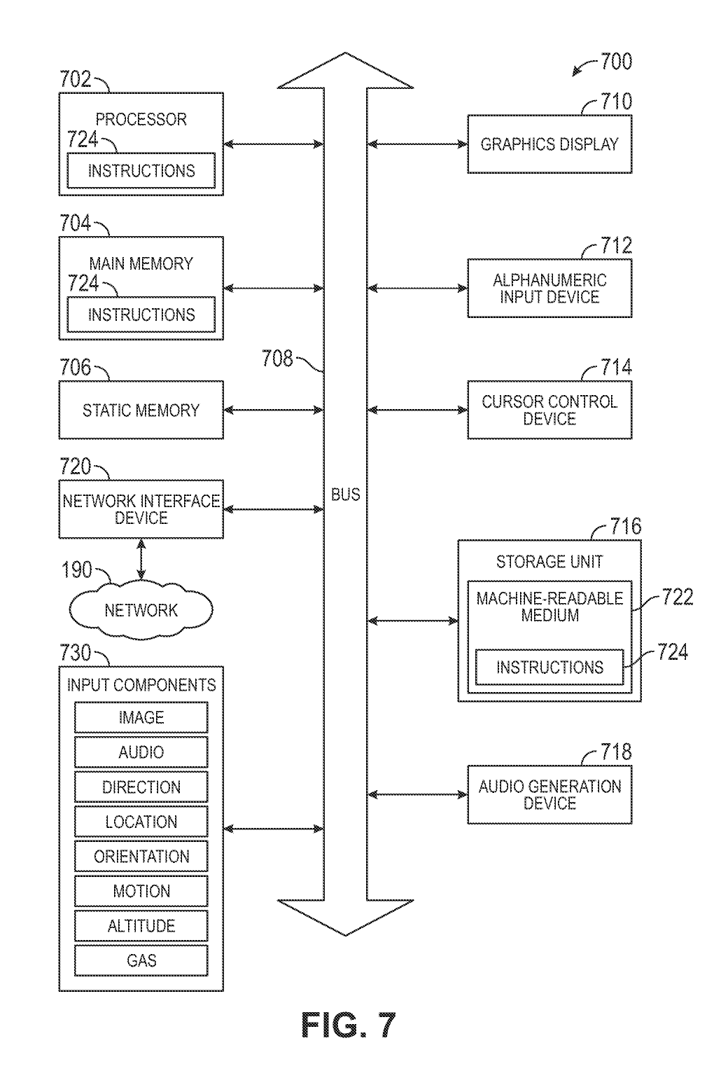

FIG. 7 is a block diagram illustrating components of a machine 700, according to some example embodiments, able to read instructions 724 from a machine-readable medium 722 (e.g., a machine-readable storage medium, a computer-readable storage medium, or any suitable combination thereof) and perform any one or more of the methodologies discussed herein, in whole or in part. Specifically, FIG. 7 shows the machine 700 in the example form of a computer system within which the instructions 724 (e.g., software, a program, an application, an applet, an app, or other executable code) for causing the machine 700 to perform any one or more of the methodologies discussed herein may be executed, in whole or in part. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media). The instructions 724 may be transmitted or received over the network 190 via the network interface device 720. For example, the network interface device 120 may communicate the instructions 724 using any one or more transfer protocols (e.g., hypertext transfer protocol (HTTP)).

In some example embodiments, the machine 700 may be a portable computing device, such as a smart phone or tablet computer, and have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

In the description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet or mobile device. The term “mobile device” includes, but is not limited to, a wireless device, a mobile phone, a mobile communication device, a user communication device, personal digital assistant, mobile hand-held computer, a laptop computer, an electronic book reader and reading devices capable of reading electronic contents and/or other types of mobile devices typically carried by individuals and/or having some form of communication capabilities (e.g., wireless, infrared, short-range radio, etc.).

What is claimed is:

1. A method comprising:
receiving vehicle service data, wherein the vehicle service data comprises service work performed on vehicles over a predetermined period of past time;
calculating an estimated future demand for vehicle service work over a predetermined period of future time based on the vehicle service data;
calculating an estimated maximum future capacity for vehicle service work over the predetermined period of future time based on the vehicle service data;
analyzing constraints on the capacity for vehicle service work over the predetermined period of future time;
modifying the estimated maximum future capacity for vehicle service work over a predetermined period of future time based on the constraints;
determining a difference between the estimated maximum future capacity for vehicle service work over a predetermined period of future time and the estimated future demand; and
converting the difference into monetary value.

2. The method of claim 1, further comprising:
causing a graphical display of a comparison between the estimated future demand and the estimated maximum future capacity.

3. The method of claim 1, wherein the vehicle service data is received from a Dealer Management System (DMS).

4. The method of claim 1, wherein the constraints are calculated in real-time based on data received from an automobile dealer.

5. The method of claim 1, further comprising:
automatically generating promotions for vehicle service work in response to determining a difference between the estimated maximum future capacity for vehicle service work over a predetermined period of future time and the estimated future demand, wherein the estimated maximum future capacity for vehicle service work is modified based on the constraints.

6. The method of claim 1, wherein the estimated future demand for vehicle service work over a predetermined period of future time is updated in real-time based on data indicating that a scheduled appointment for a particular day has arrived.

7. A non-transitory machine-readable storage medium comprising instructions that, when executed by one or more processors of a machine, cause the machine to perform operations comprising:
receiving vehicle service data, wherein the vehicle service data comprises service work performed on vehicles over a predetermined period of past time;
calculating an estimated future demand for vehicle service work over a predetermined period of future time based on the vehicle service data;
calculating an estimated maximum future capacity for vehicle service work over the predetermined period of future time based on the vehicle service data;
analyzing constraints on the capacity for vehicle service work over the predetermined period of future time;
modifying the estimated maximum future capacity for vehicle service work over a predetermined period of future time based on the constraints;
determining a difference between the estimated maximum future capacity for vehicle service work over a predetermined period of future time and the estimated future demand; and
converting the difference into monetary value.

8. The non-transitory machine-readable storage medium of claim 7, further comprising causing a graphical display of a comparison between the estimated future demand and the estimated maximum future capacity.

9. The non-transitory machine-readable storage medium of claim 7, wherein the vehicle service data is received from a Dealer Management System (DMS).

10. The non-transitory machine-readable storage medium of claim 7, wherein the constraints are calculated in real-time based on data received from an automobile dealer.

11. The non-transitory machine-readable storage medium of claim 7, further comprising:
automatically generating promotions for vehicle service work in response to determining a difference between the estimated maximum future capacity for vehicle service work over a predetermined period of future time and the estimated future demand, wherein the estimated maximum future capacity for vehicle service work is modified based on the constraints.

12. The non-transitory machine-readable storage medium of claim 7, wherein the estimated future demand for vehicle service work over a predetermined period of future time is updated in real-time based on data indicating that a scheduled appointment for a particular day has arrived.

13. A system comprising:
a module configured to receive vehicle service data, wherein the vehicle service data comprises service work performed on vehicles over a predetermined period of past time;
a module configured to calculate an estimated future demand for vehicle service work over a predetermined period of future time based on the vehicle service data;
a module configured to calculate an estimated maximum future capacity for vehicle service work over the predetermined period of future time based on the vehicle service data;
a module configured to analyze constraints on the capacity for vehicle service work over the predetermined period of future time;
a module configured to modify the estimated maximum future capacity for vehicle service work over a predetermined period of future time based on the constraints;
a module configured to determine a difference between the estimated maximum future capacity for vehicle service work over a predetermined period of future time and the estimated future demand; and
a module configured to convert the difference into monetary value.

14. The system of claim 13, further comprising causing a graphical display of a comparison between the estimated future demand and the estimated maximum future capacity.

15. The system of claim 13, wherein the vehicle service data is received from a Dealer Management System (DMS).

16. The system of claim 13, wherein the constraints are calculated in real-time based on data received from an automobile dealer.

17. The system of claim 13, further comprising automatically generating promotions for vehicle service work in response to determining a difference between the estimated maximum future capacity for vehicle service work over a predetermined period of future time and the estimated future demand, wherein the estimated maximum future capacity for vehicle service work is modified based on the constraints.

18. The system of claim 13, wherein the estimated future demand for vehicle service work over a predetermined period of future time is updated in real-time based on data indicating that a scheduled appointment for a particular day has arrived.
